(19) United States
(12) Patent Application Publication
(10) Pub. No.: US 2012/0159375 A1
(43) Pub. Date: Jun. 21, 2012

(54) CONTEXTUAL TABS AND ASSOCIATED FUNCTIONALITY GALLERIES

(75) Inventors: Han-Yi Shaw, Redmond, WA (US); Brian T. Kelley, Bellevue, WA (US)

(73) Assignee: MICROSOFT CORPORATION, Redmond, WA (US)

(21) Appl. No.: 12/969,495

(22) Filed: Dec. 15, 2010

(51) Int. Cl. G06F 3/048

(52) U.S. Cl. 715/777

(57) ABSTRACT

Embodiments of the present invention provide a design that employs a system of tabs that have parent-child relationships. Within each tab, compartments containing selectable functionality controls may be included, wherein the compartments are logically and systematically arranged to map to the tabs under which they fall, and are shown in an order that reflects the designer's intent of priority and frequency of use.

### BACKGROUND

Computer and software users have grown accustomed to user-friendly software applications that help them write, calculate, organize, prepare presentations, send and receive electronic mail, make music, and the like. For example, modern electronic word processing applications allow users to prepare a variety of useful documents. Modern spreadsheet applications allow users to enter, manipulate, and organize data. Modern electronic slide presentation applications allow users to create a variety of slide presentations containing text, pictures, data or other useful objects.

To assist users to locate and utilize functionality of a given software application, a user interface containing a plurality of generic functionality controls is typically provided along an upper, lower or side edge of a displayed workspace in which the user may enter, copy, manipulate and format text or data. Such functionality controls often include selectable buttons with such names as “file,” “edit,” “view,” “insert,” “format,” and the like. Typically, selection of one of these top-level functionality buttons, for example “format,” causes a drop-down menu to be deployed to expose one or more selectable functionality controls associated with the top-level functionality, for example “font” under a top-level functionality of “format.”

After a user selects a desired functionality control, or if the user moves the mouse cursor to a different location, the drop-down menu typically disappears. If the user determines that functionality of the first drop-down menu was the desired functionality, the user must remember which top-level functionality was selected, reselect that functionality and then find the desired functionality control all over again. Accordingly, in order to use the functionality of a given software application, the user must know the desired functionality is available under one of the selectable buttons, or the user must select different top-level functionalities until the desired specific functionality is located. Such a method of searching for desired functionality is cumbersome and time-consuming, particularly for less experienced users, and when new functionality is added by developers of the software application, the new functionality may never be utilized unless the user is somehow educated as to its existence.

Accordingly, there is a need in the art for an improved functionality command user interface for displaying selectable software functionality controls and for presenting logical groupings of particular functionality controls associated with a selected top-level functionality. It is with respect to these and other considerations that the present invention has been made.

### SUMMARY

Embodiments of the present invention solve the above and other problems by providing an improved user interface for displaying selectable software functionality controls and for presenting contextual logical groupings of particular functionality controls associated with a selected top-level functionality utilizing parent-child relationships. The improved user interface may display a gallery of images showing application of various formatting options applicable to a selected object or document. Upon receiving an indication of a selection of an object for formatting via a software application or of a task-based tab, the user interface may be provided containing one or more formatting controls. By integrating animation functionalities, one or more contextual child extension tabs may be displayed in such a way that the child extension tab may appear extending from its parent top-level functionality tab. By utilization of animation, arrows may be utilized to indicate that two task-based tabs that may be seemingly unrelated, have a relationship.

Embodiments of the present invention provide an entry point for a gallery of selectable controls as an on-hover design that shows up when the user hovers over a gallery space within the ribbon-shaped user interface. Once revealed (upon hover-over), the gallery may stay present and serve as a toggle, whereby a user may click to cause the gallery to reveal it, and then click again to hide. When a user moves his/her cursor from the gallery space within the ribbon-shaped user interface, the entry point (trigger) may disappear. To aid discoverability and visual elegance, a fade-out effect may be utilized for gently delaying the disappearance so that it appears to linger longer visually. Embodiments of the present invention provide a design that employs a system of tabs that have parent-child relationships. Within each tab, compartments containing selectable functionality controls may be included, wherein the compartments are logically and systematically arranged to map to the tabs under which they fall, and are shown in an order that reflects the designer's intent of priority and frequency of use.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The accompanying drawings, which are incorporated in and constitute a part of this disclosure, illustrate various embodiments of the present invention. In the drawings:

FIG. 1 is a simplified block diagram of a system including a computing device with which embodiments of the invention may be practiced.

FIGS. 2A, 2B, 2C, and 2D are illustrations of a computer screen display showing a ribbon-shaped user interface for displaying task-based top-level functionality tabs, contextual extension tabs, and for displaying one or more compartments containing a plurality of functionalities available under a selected top-level functionality tab and/or contextual extension tab.

FIG. 3 is an illustration of various selectable functionalities grouped into various compartments or pods.

FIGS. 4A and 4B illustrate various types of selectable functionality controls that may be included in a compartment or pod.

FIG. 5A is an illustration of a ribbon-shaped user interface for providing a gallery of images illustrating the application of one or more formatting options to a selected object.

FIG. 5B is an illustration of a ribbon-shaped user interface for providing a gallery of images illustrating the application of one or more elements options to a selected object.

FIG. 6 is an illustration of a ribbon-shaped user interface for providing a single-button dropdown menu of selectable functionality controls.

FIG. 7 is an illustration of a ribbon-shaped user interface for providing a supplemental gallery of selectable functionality controls.

FIG. 8 is an illustration of a basic supplemental gallery of selectable functionality controls.

FIG. 9 is an illustration of a complex supplemental gallery of selectable functionality controls.

### DETAILED DESCRIPTION

As briefly described above, embodiments of the present invention solve the above and other problems by providing an improved user interface for displaying selectable software functionality controls and for presenting contextual logical groupings of particular functionality controls associated with a selected top-level functionality utilizing parent-child relationships. Embodiments of the present invention provide a design that employs a system of tabs that have parent-child relationships. Within each tab, compartments containing selectable functionality controls may be included, wherein the compartments are logically and systematically arranged to map to the tabs under which they fall, and are shown in an order that reflects the designer's intent of priority and frequency of use. The improved user interface may display a gallery of images showing application of various formatting options applicable to a selected object or document.

As will be described in detail below, when a standard functionality tab is selected from the ribbon-shaped user interface of the present invention, or when an object within a displayed document is selected, the selected standard functionality tab or a standard functionality tab associated with the selected object may then become a contextual host tab, wherein one or more contextual extension tabs may be presented in the ribbon-shaped user interface extending from the standard functionality tab. Logical groupings of selectable functionality controls of related features associated with the standard functionality tab and the one or more contextual extension tabs may be revealed in the ribbon-shaped user interface, and within close proximity to their designated entry point. Each logical grouping will herein be referred to as a pod.

A pod may be presented in a ribbon-shaped user interface above a workspace in which as user is entering or editing a document or object, or in one of various gallery types, wherein a gallery is a scrollable list of selectable features. For example, if a word processing application is used, and the user selects on an in-document table, a “Table Formatting” contextual tab may extend from a standard “Tables” tab within the ribbon-shaped user interface. Additionally, functionalities associated with tables and table formatting may populate one or more pods within the ribbon-shaped user interface, and/or in one of various control galleries.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

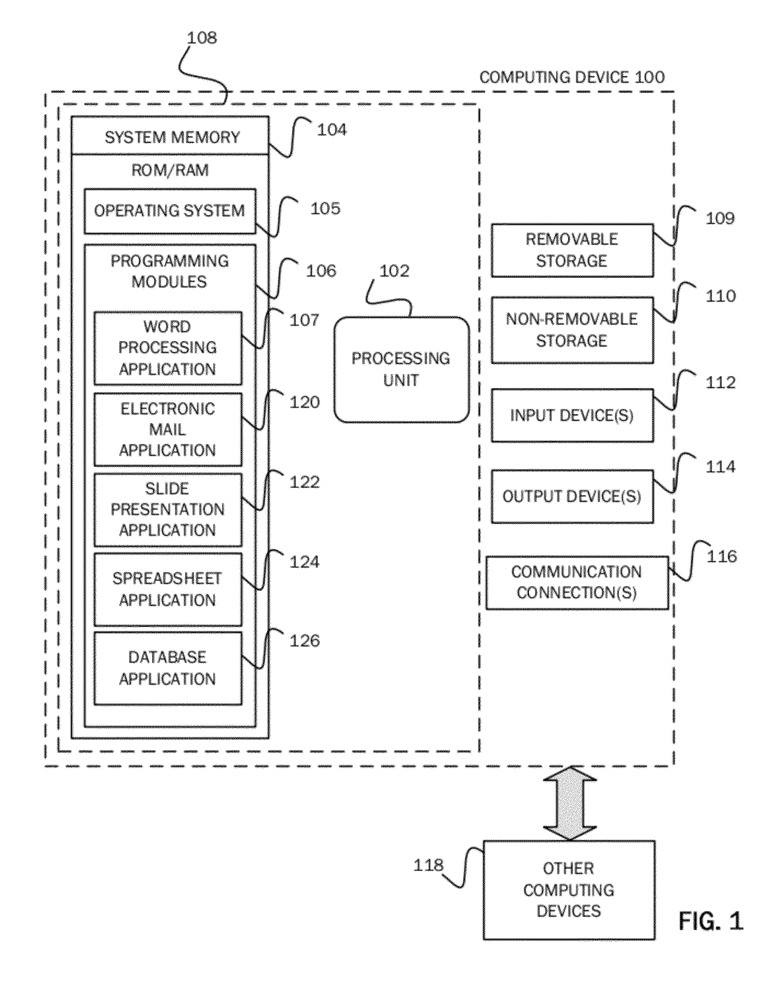

Referring now to the drawings, in which like numerals represent like elements through the several figures, aspects of the present invention and the exemplary operating environment will be described. FIG. 1 and the following discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other program modules.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

As mentioned briefly above, a number of program modules 106 and data files may be stored in the system memory 104 and RAM of a computing device 100, including an operating system 105 suitable for controlling the operation of a networked personal computer, such as the WINDOWS operating systems from MICROSOFT CORPORATION of Redmond, Wash. The system memory 104 and RAM may also store one or more application programs. In particular, the system memory 104 and RAM may store various application programs for providing a variety of functionalities to a user. Application programs may include a word processing application 107, electronic mail application 120, slide presentation application 122, spreadsheet application 124, and/or database application 126.

The term computer readable media as used herein may include computer storage media. Computer storage media may include volatile and nonvolatile, removable and non-removable media implemented in any method or technology for storage of information, such as computer readable instructions, data structures, program modules, or other data. System memory 104, removable storage 109, and non-removable storage 110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 100. Any such computer storage media may be part of device 100. Computing device 100 may also have input device(s) 112 such as a keyboard, a mouse, a pen, a sound input device, a touch input device, etc. Output device(s) 114 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

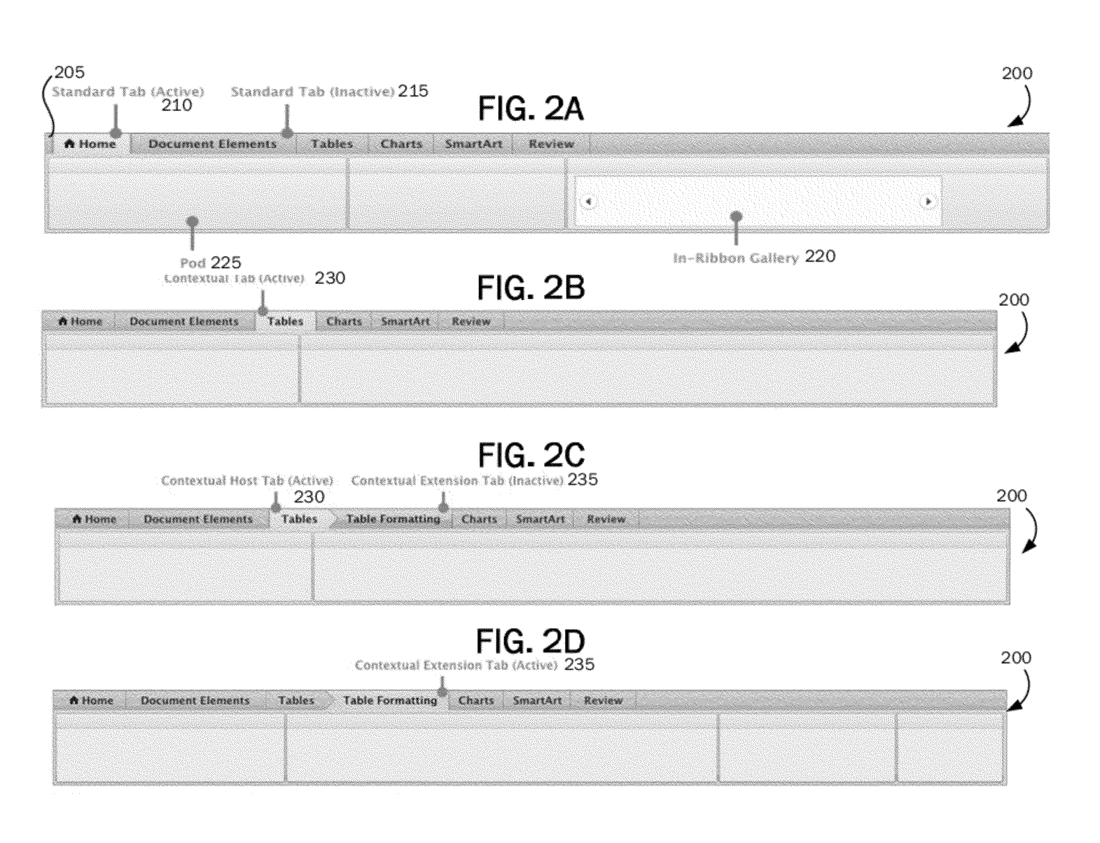

FIG. 2A is an illustration of a ribbon-shaped user interface for displaying task-based top-level functionality tabs and for displaying a functionality control section containing a plurality of functionalities available under a selected top-level functionality tab. As briefly described above, the improved user interface of the present invention includes a ribbon-shaped user interface for displaying controls presenting logical groupings of particular functionality controls associated with a selected top-level functionality in a single embedded user interface element. A first section 205 of the ribbon-shaped user interface 200 includes standard controls 210 for core features of an application 107. A standard controls section 205 may include a “Home” standard tab 210, which when selected, may display frequently used tools, such as font and paragraph formatting. Other commonly used tools, such as those for page layout, tables, charts, SmartArt, and review, may be located within their own standard tabs 210,215. Standard tabs 210,215 may comprise descriptive names to help users better search for a command.

According to embodiments, the improved user interface of the present invention may be context-sensitive, wherein relevant controls may be displayed when applicable, and may be hidden when not applicable. Selectable controls may be logically categorized beneath a parent standard tab 210,215. For example, table-related formatting controls may appear within a contextual tab of their own, and within close proximity to their designated entry point (e.g., “Tables” tab 230). According to embodiments, selectable controls in a contextual tab 230 may be specific to a particular object. If a document has an object that has an associated contextual tab 230, and if the object is selected, the associated contextual tab may become active in the ribbon-shaped user interface 200 as shown in FIG. 2B. According to embodiments, upon detection of a selection of an associated object or selection of a standard tab, the standard tab 210 may switch to a parent tab, also referred to as a contextual host tab 230, wherein one or more contextual child tabs of the contextual host tab may be displayed. The one or more contextual child tabs, also referred to as contextual extension tabs 235, may animate out of the associated contextual host tab 230.

According to embodiments, upon detection of a selection of an object, the contextual tab 230,235 associated with the selected object may become immediately available, even if the contextual tab is not a currently selected tab 215. With previous user interface designs, a user may be using a contextual tab 230,235 for an object, and after making a formatting change, may click away from the object to better see the results of his/her change. Upon clicking away, the object may no longer be selected, and consequently, the selection functionality controls may disappear. The user may immediately click back on the object to continue working with it, and discover that the contextual tab associated with the object is no longer selected. Embodiments of the present invention provide for an automatic navigation back to a contextual tab 230,235 when a detection is made of a user selected an object, deselected it, and then reselected the object on his/her next click.

Referring now to FIGS. 2C and 2D, a “Table Formatting” contextual extension tab 235 is shown extended from the right side of the “Tables” contextual host tab 230, which has morphed from a rectangular shape (shown in FIG. 2B) into an arrow pointing toward the contextual extension tab. When a user clicks away from an object or tab, the contextual extension tab 235 may morph back into the associated parent contextual host tab 230. The animation may help users become aware of the parent-child relationship of the displayed tabs.

According to embodiments, the improved ribbon-shaped user interface 200 of the present invention may include compartments or groupings of selectable functionality controls, herein referred to as pods 225. The improved ribbon-shaped user interface 200 may include one or more pods 225 containing closely related features that may fall under either a standard tab 210,215, 230 or a contextual extension tab 235. For example, a “Home” tab 210 may include “Font,” “Paragraph,” and “Styles” pods.

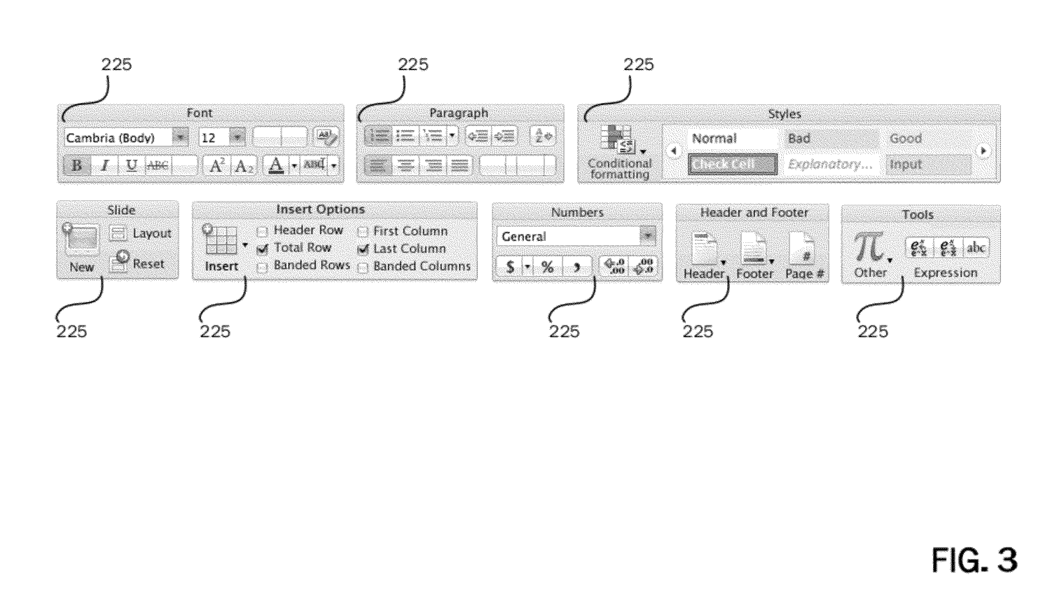

Referring now to FIG. 3, various examples of pod types 225 are shown. As illustrated, a pod 225 may include selectable functionality controls for such features as, but not limited to, font formatting, paragraph formatting, styles formatting, slide formatting, insert options, numbers, header and footer, and tools.

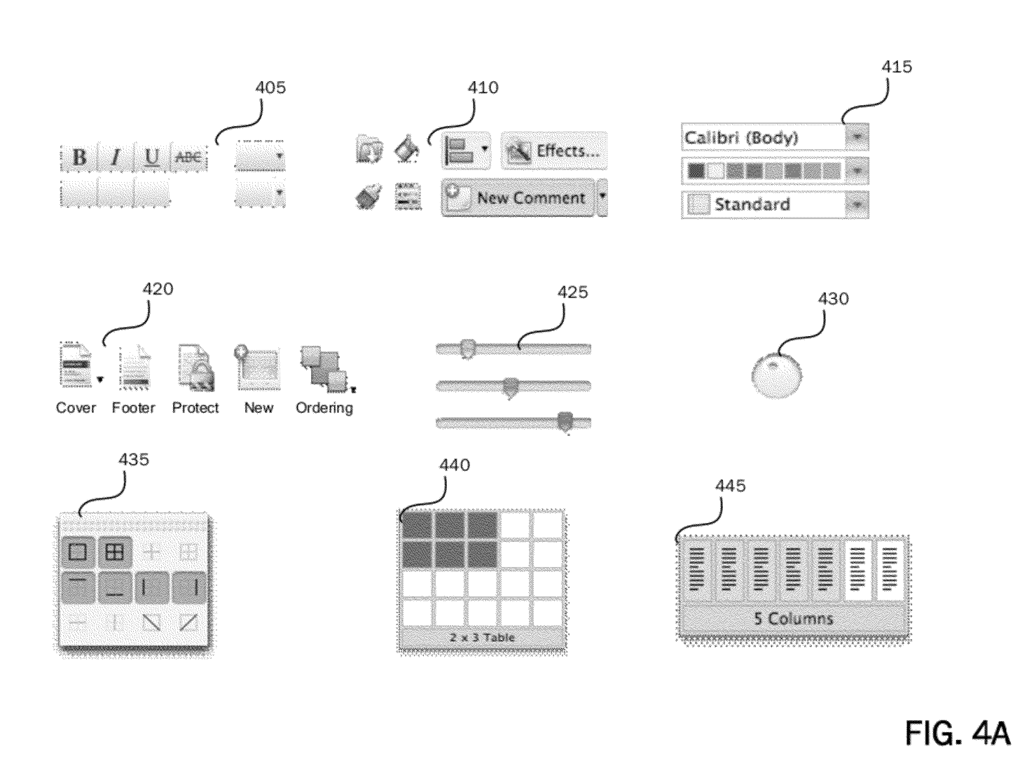

Referring now to FIGS. 4A and 4B, various types of selectable functionality controls may be included in the improved ribbon-shaped user interface 200 of the present invention. For example, and as shown in FIGS. 4A and 4B, the ribbon-shaped user interface 200 may include segmented controls 405, single height buttons 410, dropdown menus 415, double height buttons 420, sliders 425, dials 430, icon dropdown menus 435, tables insert menus 440, columns insert menus 445, color set picker menus 450, theme font menus 455, color picker menus 460,470, and/or icons plus multi-line text menus 465. An option may be provided for magnifying images for single height buttons 410.

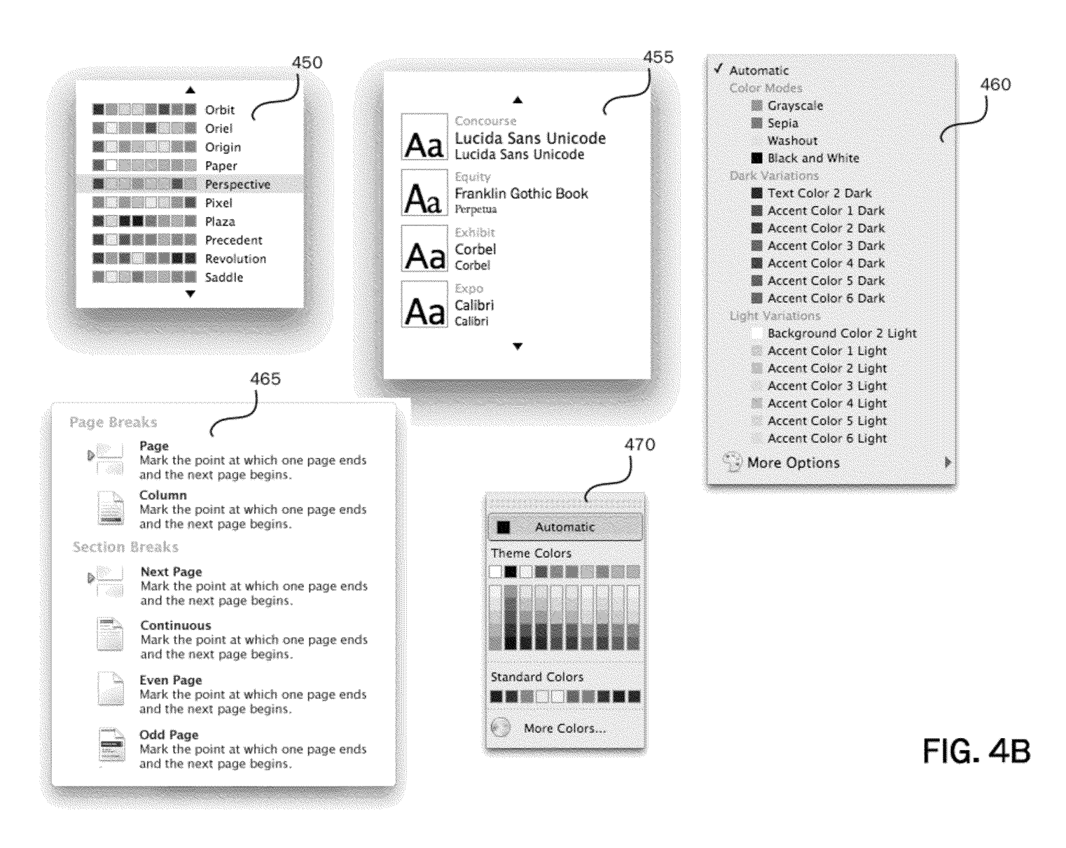

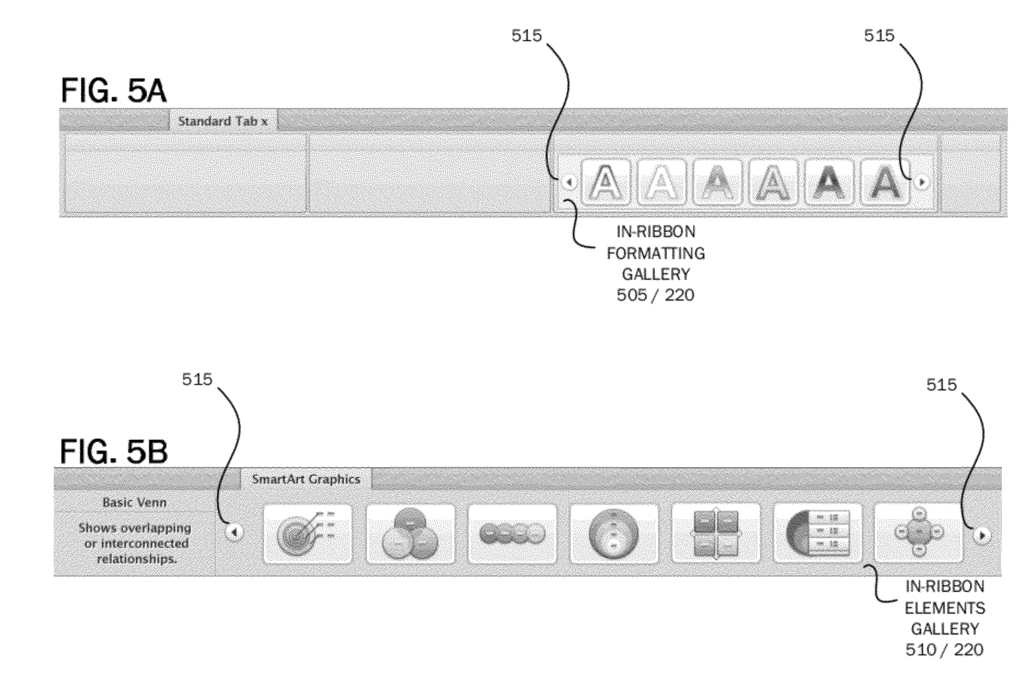

According to embodiments, one or more galleries of formatting controls may be included in the ribbon-shaped user interface 200. Each formatting control may illustrate formatting options that may be applied to a selected object. Galleries of images may be presented to a user as an in-ribbon gallery of images disposed horizontally within the ribbon-shaped user interface 200, as illustrated in FIGS. 5A and 5B. Each image may represent the way in which a selected document or object may be formatted if the formatting options illustrated by a given image is applied to the selected document or object.

An in-ribbon formatting gallery 505 may include visual images that may be used as a starting point. The images may continuously and dynamically update based on in-document user action (e.g., formatting). For example, a “Styles” formatting in-ribbon gallery 505 may change its image when a user updates the formatting of a selected piece of text (e.g., “Heading 1” to “Heading 1”). As another example, in a “Tables” formatting in-ribbon gallery 505, if a user clicks on a checkbox to include a total row, all table images may update to show the total row in the gallery. This may allow users to cross-reference between the in-gallery image and the in-document content. That is, if a user clicks on an in-document table, the user may look at the gallery and see that the total row is applied; if the user has not inserted the table, he/she can look at the in-gallery image to get an idea of what the result may look like before inserting the table.

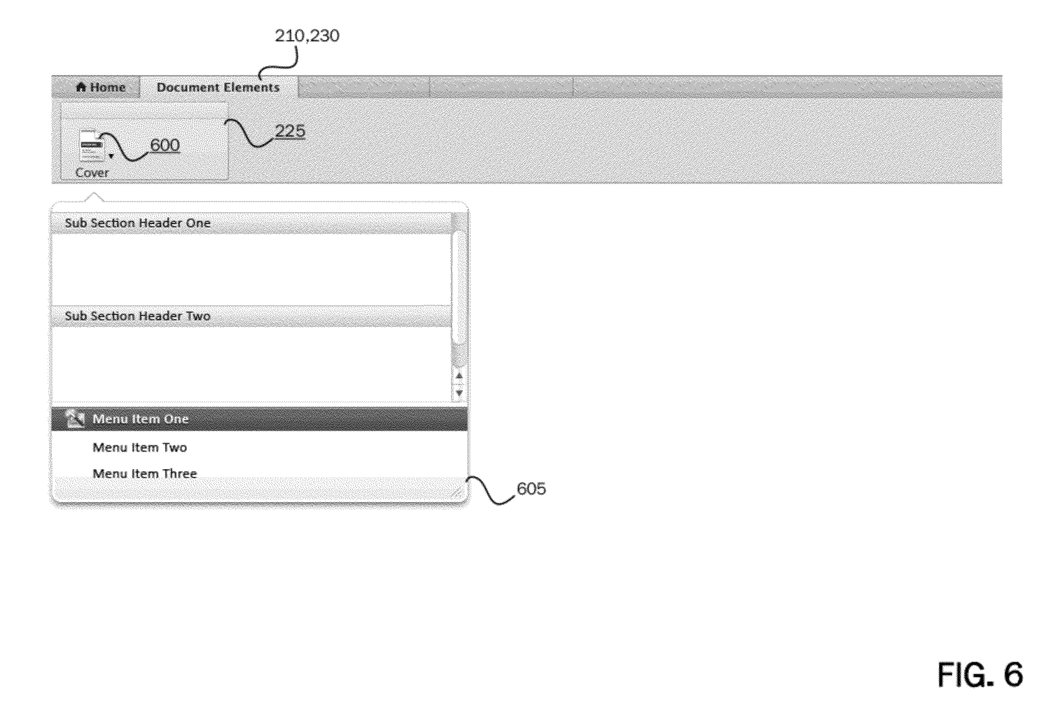

An in-ribbon formatting gallery 505 may be found amongst adjacent pods 225 in the ribbon-shaped user interface 200. In-ribbon formatting galleries 505 may be formatting-centric, and thus, may have dependency on other formatting controls. A limitation of the in-ribbon formatting gallery 505 is that, since it resides amongst other pods 225, sometimes, only three or four images may be shown at a given time. As will be described in more detail below with reference to FIG. 6, a supplemental gallery menu may be provided as an extension to the in-ribbon formatting gallery 505.

Another type of in-ribbon gallery of formatting controls is an in-ribbon elements gallery 510, as illustrated in FIG. 5B. An in-ribbon elements gallery 510 may be utilized as a launch pad for a given object type. For example, a Charts or SmartArt image may convey a “type” of object (i.e., Chart or SmartArt), and not it's “formatting.” The difference between a donut chart and a bubble chart is “chart type,” and not “chart formatting.” Similarly, a “vertical picture accent list” diagram differs from a “basic timeline” diagram in its type, not its formatting. If a user wants to format a given chart or diagram (e.g., a bubble chart or basic timeline diagram), selecting on said object may reveal a contextual extension tab 235, which may reveal various selectable formatting controls. An in-ribbon element gallery 510 provides selectable controls in a user interface 200 in a way that that it does not compete with other pods 225 in the user interface. Additionally, the in-ribbon element gallery 510 does not employ supplemental menu dropdowns, which my be large in size, and may obscure document content.

Scroll buttons 515 may be utilized in the in-ribbon gallery of images 505,510 where more images are available than may be displayed in the user interface 200 based on available space. Accordingly, the scroll buttons 515 allow a user to scroll through all available images before selecting a particular image. Scrolling may not be circular, wherein if a user has scrolled to the first or last set of images, further scrolling may not take place. Scrolling animation may be included, which may provide for continuous or live-scrolling.

Embodiments of the present invention provide an entry point for a gallery of selectable controls as an on-hover design that shows up when the user hovers over a gallery space 220,505,510 within the ribbon-shaped user interface 200. Once revealed (upon hover-over), the gallery may stay present and serve as a toggle, whereby a user may click to show the gallery to reveal it, and then click again to hide. When a user moves his/her cursor from the gallery space within the ribbon-shaped user interface, the entry point (trigger) may disappear. To aid discoverability and visual elegance, a fade-out effect may be utilized for gently delaying the disappearance so that it appears to linger longer visually.

According to an embodiment, an image displayed in an in-ribbon formatting gallery 505,510 may be in a normal selection highlight state. If an image displayed in an in-ribbon formatting gallery 505,510 is selected and the corresponding formatting is applied to an object or a document. The image may be in a selected selection highlight state. If a user hovers a cursor over an image displayed in an in-ribbon formatting gallery 505,510, the image may be in a hover-over selection highlight state.

According to an embodiment of the present invention, the width of an in-ribbon gallery of images 505,510 may auto-resize along with the ribbon-shaped user interface 200 width (which may be determined by window width), to display the maximum number of images. When an in-ribbon gallery 505,510 is present under a given tab 215,230, the pod 225 may fill the entire width of the ribbon-shaped user interface 200.

As shown in FIG. 6, a single-button dropdown gallery of images is illustrated. According to an embodiment and as shown in FIG. 6, a single button 600 (i.e., selectable control) may be displayed in the ribbon-shaped user interface 200 within a pod 225 under a task-based tab 210,230. Upon selection of the single button 600, a gallery of images may be displayed in a supplemental gallery menu 605. The single-button dropdown gallery 605 may not have a parent in-ribbon gallery (e.g., in-ribbon formatting gallery 505, in-ribbon element gallery 510), but instead, may rely on a single button dropdown 600 to invoke the supplemental gallery menu 605. The single-button dropdown gallery 605 may be best suited for feature options that may not require the same level of feature elevation as in-ribbon galleries 220,505,510.

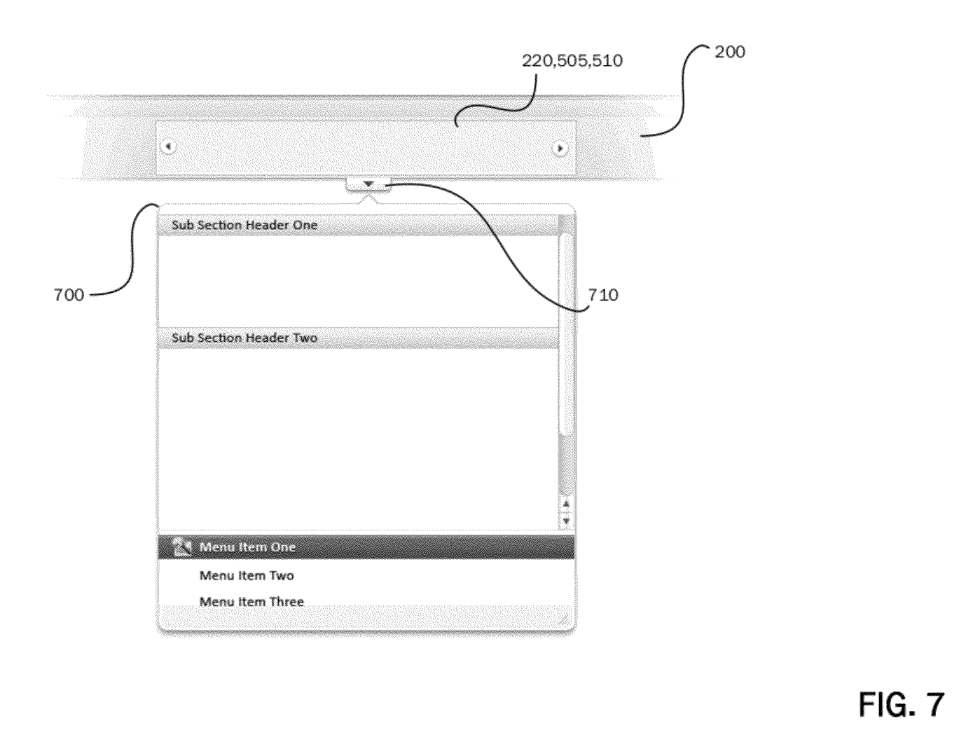

According to another embodiment, and as shown in FIG. 7, a supplemental gallery menu 700 may be provided as an extension to an in-ribbon gallery 220,505,510 when there may be more gallery image options than can be shown in the ribbon-shaped user interface 200. A supplemental gallery menu 700 of selectable functionality controls may be invoked when a user hovers over any region inside the gallery display region. When a user hovers over the gallery display region 700, a gallery dropdown arrow 710 may appear. According to embodiments, the gallery dropdown arrow 710 may appear immediately (e.g., quick fade-in of 0.5 seconds) when a user moves a cursor over the gallery display region 700. The gallery dropdown arrow 710 may linger for a given time period (e.g., one second after a cursor has exited the gallery 700), and may then fade out over another given time period (e.g., slow fade-out of one second).

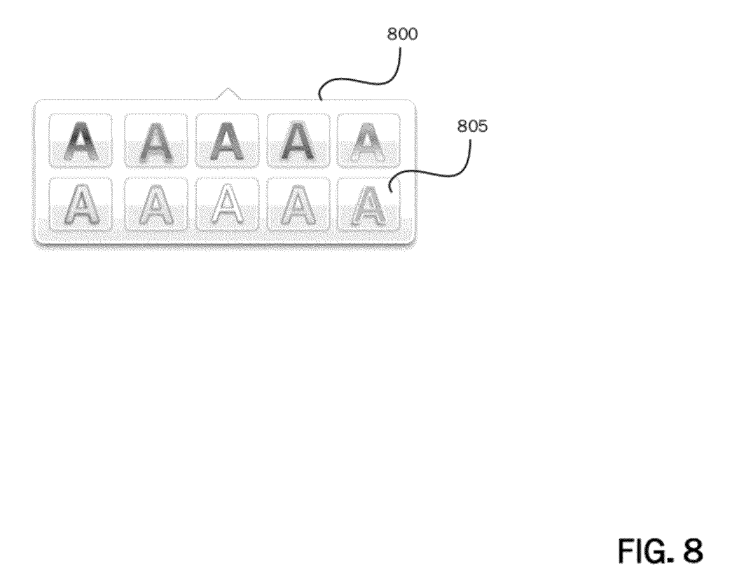

According to embodiments, selectable images displayed in a gallery may be static images, or the images may be live images that may be dynamically altered based on user input and based on the actual selected object to which the images apply. A dynamic formatting gallery may support two types of supplemental gallery menus 700: basic and complex. A client application (e.g., MICROSOFT WORD, MICROSOFT EXCEL, MICROSOFT POWERPOINT, MICROSOFT OUTLOOK, etc.) may be able to choose from one of the two types based on needs of the functional requirements of the application. A basic supplemental gallery menu is illustrated in FIG. 8. According to embodiments, a simple supplemental gallery menu 800 may contain only an array of selectable images 805.

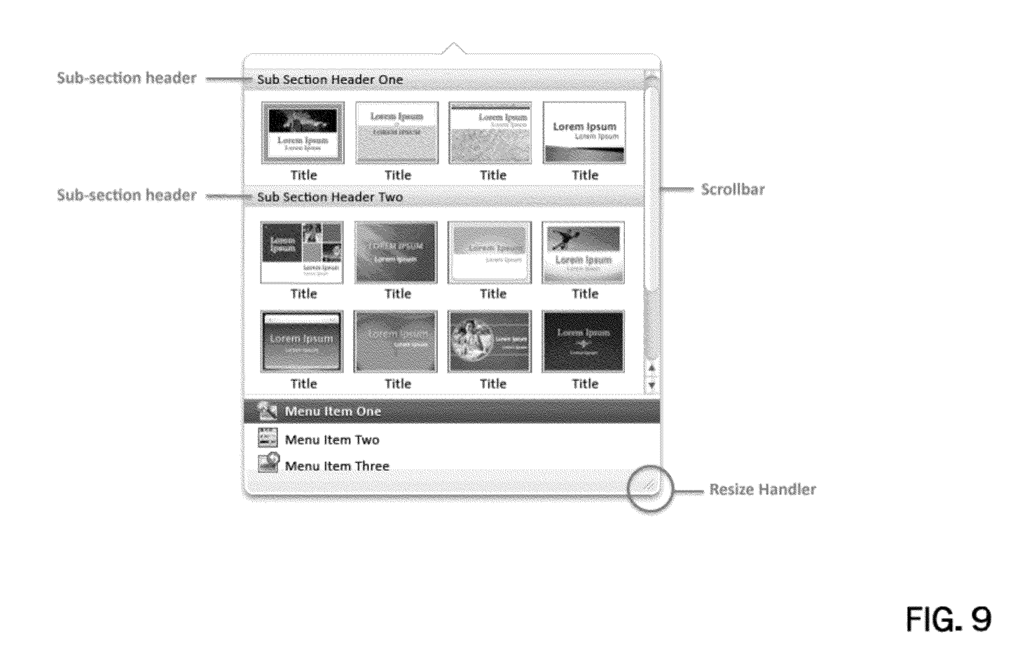

A complex supplemental gallery menu is illustrated in FIG. 9. According to embodiments, a complex supplemental gallery menu 900 may include the following sub-components: sub-gallery sections 905, menu 910, a scrollbar 915, and a resize handler 920. The sub-gallery section 905 may include a sub-section header 925, sub-section images 930, and image text labels 935. The menu 910 may include a menu string 940 and menu icons 945. The scrollbar 915 may appear when all images for a given dropdown gallery do not fit in the default dropdown gallery area 700,800,900, which may differ based on client functionality.

As shown in FIG. 9, by default, when a supplemental gallery menu 700,800,900 is displayed, it may be displayed directly below the parent dynamic formatting gallery 220,505,510. In cases where window positioning does not allow for the supplemental gallery menu 700,800,900 to be displayed directly under the parent gallery 220,505,510, it may be shown on the side. The supplemental gallery menu 700,800,900 may appear below, left, or right from the parent gallery 220505,510, depending on available space.

A supplemental gallery menu 700,800,900 may be dismissed if a user makes a selection from the menu, if a user clicks outside the borders of the menu, moves window position, or if a user switches to another window.

According to embodiments, resizing a window may affect the layout of a ribbon-shaped user interface 200. A tool pod 225 may have a compact variant that may be used when a window width is too small to show all the pods in their full size. When a user shrinks a window, a displayed gallery may shrink until it may only hold one image. As the size shrinks further, compact pods 225 may replace the full-size variants. This may continue until all full-size pods 225 have been replaced with compact pods. If a user further shrinks the size of the window, the ribbon-shaped user interface 200 may be clipped. The ribbon-shaped user interface 200 may not be hidden if the window gets too narrow.

The ribbon-shaped user interface 200 may include various animations, such as a ribbon tab animation (e.g., contextual extension reveal animation) and menu animations (e.g., hover over fade in/out animation, contextual extension reveal animation, etc.).

According to embodiments, customization capabilities may be provided to users by allowing users to turn on/off “optional ribbon tabs” that may be useful for a specific scenario (e.g., VISUAL BASIC authoring) or to turn on/off “optional ribbon pods” that may be intended for experienced users or other smaller subsets of a type of user. An optional pod may be defined as a pod 225 that may not be shown by default, but may be turned on by a user. For example, an optional pod 225 may be a “Paragraph Indents and Spacing” pod 225 in a “Home” tab 210. By default, the “Paragraph Indents and Spacing” pod 225 is hidden; however, a user may turn it on from a preferences menu.

According to embodiments, other customization capabilities may be provided including, but not limited to, allowing for a user to change the order of individual tabs 210,215, allowing for a user to hide individual tabs, and allowing for a user to hide a subset of pods 225 within a tab 210,215.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing functionality from a software application via an improved user interface, comprising:
providing a plurality of functionalities available from the software application;
organizing the plurality of functionalities according to one or more tasks that may be performed with the software application;
providing in the user interface, a plurality of contextual user interface tabs of top-level controls;
upon receiving an indication of a selection of a first contextual user interface tab or an object associated with a first contextual user interface tab, providing in the user interface one or more contextual extension tabs extending from the first contextual user interface tab; and
providing one or more compartments of selectable controls associated with the plurality of functionalities organized according to one or more tasks that may be performed with the software application and mapped to the associated contextual user interface tab.

2. The method of claim 1, wherein providing in the user interface one or more contextual extension tabs extending from the first contextual user interface tab includes a use of animation for displaying an extension of the one or more contextual tabs.

3. The method of claim 1, wherein providing one or more compartments of selectable controls includes providing a gallery of selectable controls within the user interface.

4. The method of claim 3, further comprising providing a right-to-left and a left-to-right scrolling means for scrolling a plurality of selectable controls displayed in the gallery of selectable controls from right-to-left or left-to-right within the user interface.

5. The method of claim 1, wherein providing one or more compartments of selectable controls includes providing a gallery of selectable controls in a supplemental gallery menu.

6. The method of claim 5, wherein providing a gallery of selectable controls in a supplemental gallery menu is invoked when a cursor is hovered over any region inside a gallery display region.

7. The method of claim 3, further comprising upon a cursor hover over the gallery of selectable controls within the user interface, displaying a selectable dropdown arrow extending below a gallery display region containing the gallery of selectable controls within the user interface.

8. The method of claim 7, wherein displaying a dropdown arrow extending below a gallery display region includes a use of animation for showing a relationship between the gallery display region and a supplemental gallery menu.

9. The method of claim 8, wherein upon receiving a first selection of the dropdown arrow, displaying a supplemental gallery menu beneath the user interface for exposing one or more additional selectable controls; and wherein upon receiving a second selection of the dropdown arrow, removing the display of the supplemental gallery menu.

10. A computer readable medium containing computer-executable instructions which when executed by a computer perform a method for providing functionality from a software application via an improved user interface, comprising:
providing a plurality of functionalities available from the software application;
organizing the plurality of functionalities according to one or more tasks that may be performed with the software application;
providing in the user interface, a plurality of contextual user interface tabs of top-level controls;
upon receiving an indication of a selection of a first contextual user interface tab or an object associated with a first contextual user interface tab, providing in the user interface one or more contextual extension tabs extending from the first contextual user interface tab; and
providing one or more compartments of selectable controls associated with the plurality of functionalities organized according to one or more tasks that may be performed with the software application and mapped to the associated contextual user interface tab.

11. The computer readable medium of claim 10, wherein providing in the user interface one or more contextual extension tabs extending from the first contextual user interface tab includes a use of animation for displaying an extension of the one or more contextual tabs.

12. The computer readable medium of claim 10, wherein providing one or more compartments of selectable controls includes providing a gallery of selectable controls within the user interface.

13. The computer readable medium of claim 12, further comprising providing a right-to-left and a left-to-right scrolling means for scrolling a plurality of selectable controls displayed in the gallery of selectable controls from right-to-left or left-to-right within the user interface.

14. The computer readable medium of claim 13, wherein providing one or more compartments of selectable controls includes providing a gallery of selectable controls in a supplemental gallery menu.

15. The computer readable medium of claim 14, wherein providing a gallery of selectable controls in a supplemental gallery menu is invoked when a cursor is hovered over any region inside a gallery display region.

16. The computer readable medium of claim 12, further comprising upon a cursor hover over the gallery of selectable controls within the user interface, displaying a selectable dropdown arrow extending below a gallery display region containing the gallery of selectable controls within the user interface.

17. The computer readable medium of claim 16, wherein displaying a dropdown arrow extending below a gallery display region includes a use of animation for showing a relationship between the gallery display region and a supplemental gallery menu.

18. The computer readable medium of claim 17, wherein upon receiving a first selection of the dropdown arrow, displaying a supplemental gallery menu beneath the user interface for exposing one or more additional selectable controls; and wherein upon receiving a second selection of the dropdown arrow, removing the display of the supplemental gallery menu.

19. A method for providing functionality from a software application via an improved user interface, comprising:
providing a plurality of functionalities available from the software application;
organizing the plurality of functionalities according to one or more tasks that may be performed with the software application;
providing in the user interface, a plurality of contextual user interface tabs of top-level controls;
upon receiving an indication of a selection of a first contextual user interface tab or an object associated with a first contextual user interface tab, providing in the user interface one or more contextual extension tabs extending from the first contextual user interface tab using an animation for displaying an extension of the one or more contextual tabs; and
providing a gallery of selectable controls in a gallery display region of the user interface, the gallery of selectable controls being associated with the plurality of functionalities organized according to one or more tasks that may be performed with the software application and mapped to the associated contextual user interface tab, wherein.

20. The method of claim 19, further comprising
upon a cursor hover over the gallery of selectable controls within the user interface, displaying a selectable dropdown arrow extending below a gallery display region containing the gallery of selectable controls within the user interface;
upon receiving a first selection of the dropdown arrow, displaying a supplemental gallery menu beneath the user interface for exposing one or more additional selectable controls; and
upon receiving a second selection of the dropdown arrow, removing the display of the supplemental gallery menu.
